(19) United States
(12) Patent Application Publication
(10) Pub. No.: US 2013/0165313 A1
(43) Pub. Date: Jun. 27, 2013

(54) FERROELECTRIC FILM, SOL-GEL SOLUTION, FILM FORMING METHOD AND METHOD FOR MANUFACTURING FERROELECTRIC FILM

(71) Applicants: Takeshi Kijima, Nagareyama-shi (JP); Yuuji Honda, Nagareyama-shi (JP); Takekazu Shigenai, Nagareyama-shi (JP)

(72) Inventors: Takeshi Kijima, Nagareyama-shi (JP); Yuuji Honda, Nagareyama-shi (JP); Takekazu Shigenai, Nagareyama-shi (JP)

(21) Appl. No.: 13/809,264

(22) PCT Filed: Jul. 12, 2010
(86) PCT No.: PCT/JP2010/062032

§ 371 Date: Mar. 11, 2013

(51) Int. Cl. C04B 35/49; B05D 5/12

(52) U.S. Cl. CPC C04B 35/49; B05D 5/12
USPC 501/135; 427/58; 427/126.3

(57) ABSTRACT

To produce a ferroelectric film including a non-lead material. An embodiment of the present invention is a ferroelectric film characterized by being represented by (Baₐα₁₋ₐ)(Ti_{b}β_{1-b}(α: one or more metal elements among Mg (magnesium), Ca2+ (calcium), Sr (strontium), Li (lithium), Na (sodium), K (potassium), Rb (rubidium), Cs (cesium), Mg (magnesium), Ca2+ (calcium) and Sr (strontium), β: one or more metal elements among Ti (titanium), V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)).

### TECHNICAL FIELD

The present invention relates to a ferroelectric film, a sol-gel solution, a film forming method using the sol-gel solution, a ferroelectric material film formed by the film forming method and a method for manufacturing a ferroelectric film.

### BACKGROUND ART

Barium titanate is represented by a chemical formula of BaTiO₃, which is a ferroelectric substance including a perovskite structure and is used as a dielectric material such as a ceramic multilayer capacitor or the like because it has an extremely high relative permittivity.

In addition, Ba(Sr, Ti)O₃ obtained by adding strontium to barium titanate is known to be able to produce a ferroelectric film.

Furthermore, as a ferroelectric film, Pb(Zr, Ti)O₃ including a perovskite structure is known.

Meanwhile, it is known that although barium titanate and barium titanate strontium belong to the ferroelectric substance, they have phase transition temperatures between a ferroelectric phase and a paraelectric phase of as low as 130° C. and not more than 90° C., respectively and that they are formed into a crystalline structure close to a cubical crystal at room temperature, thereby making it difficult to obtain ferroelectric characteristics. Therefore, in order to cause them to develop ferroelectric characteristics, it is necessary to change the crystalline structure from approximately a cubical crystal to a tetragonal crystal by strain and to orient it to a polarization axis direction. In addition, among others, a problem to be solved is that, since the phase transition temperature Tc is low, working temperatures are limited to a low temperature range to give poor temperature characteristics (generally, the upper limit of a working temperature is considered to be approximately Tc/2).

In contrast, PZT has a Tc of not less than 300° C., and has good ferroelectric characteristics and good piezoelectric characteristics. However, the achievement of lead-free is a problem to be solved in the industry-wide trend of aiming at lead-free.

### PRIOR ART DOCUMENTS

### Non-Patent Document

Non-Patent Document 1: Lead-free Piezoelectric Ceramics Device, Yokendo, Ed. by The Japan Society of Applied Electromagnetics and Mechanics (2008), P 1

### DISCLOSURE OF THE INVENTION

### Problems to be Solved

As described above, in the industrial world, the production of a ferroelectric film made of a lead-free material is required.

An embodiment of the present invention aims at producing a ferroelectric film made of a lead-free material.

### Solutions to the Problems

The following (1) to (23) describe a plurality of embodiments of the invention.

(1) A ferroelectric film represented by (Baₐα₁₋ₐ) (Ti_{b}β_{1-b})O₃ (α: one or more metal elements among Mg (magnesium), Ca2+ (calcium), Sr (strontium), Li (lithium), Na (sodium), K (potassium), Rb (rubidium), Cs (cesium), Mg (magnesium), Ca2+ (calcium) and Sr (strontium), β: one or more metal elements among Ti (titanium), V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)).

(2) The ferroelectric film according to the above (1), wherein said α is an alkali metal element.

(3) The ferroelectric film according to the above (2), wherein said α is Ca.

(4) The ferroelectric film according to any one of the above (1) to (3), wherein a and b satisfy Expressions (A) and (B) below:
(A) 0.5≦a≦1
(B) 0≦b≦0.5

(5) The ferroelectric film according to any one of the above (1) to (4), wherein said (Baₐα₁₋ₐ) (Zr_{b}Ti_{1-b})O₃ includes a perovskite structure.

(6) A sol-gel solution for forming a ferroelectric film on a substrate, wherein the sol-gel solution contains a raw material solution mixed with a heteropoly acid including Ba, X, Zr, and Ti.

(7) The sol-gel solution according to the above (6), including a heteropoly acid ion as a part of a precursor structure of ferroelectric ceramics, the heteropoly acid ion being based on a heteropoly acid ion having a Keggin-type structure in which a molecular structure is made non-centrosymmetric to express nonlinearity as a constituent component, wherein at least one poly atom of the heteropoly acid ion is deficient or a part of poly atoms of the heteropoly acid ion is substituted with another atom.

(8) The sol-gel solution, wherein the heteropoly acid ion includes the one described in the above (7) having a Keggin-type structure represented by a following Formula: [XM_{y}M′_{12-y}O₄₀]ⁿ⁻ (where, X is a hetero atom, M is a poly atom, M′ is a poly atom different from M, n is a valence number, and y=1 to 11), as a part of a precursor structure of ferroelectric ceramics.

(9) The sol-gel solution, wherein the heteropoly acid ion includes the one described in the above (7) having a Keggin-type structure represented by a Formula: [XM₁₁O₃₉]ⁿ⁻ (where, X is a hetero atom, M is a poly atom, and n is a valence number), as a part of a precursor structure of ferroelectric ceramics.

(10) The sol-gel solution, wherein the heteropoly acid ion includes the one described in the above (7) having a Keggin-type structure represented by a following Formula: [XM_{z}M′_{11-z}O₃₉]ⁿ⁻ (where, X is a hetero atom, M is a poly atom, M′ is a poly atom different from M, n is a valence number, and z=1 to 10), as a part of a precursor structure of ferroelectric ceramics.

(11) The sol-gel solution according to any one of the above (8) to (10) including the heteropoly acid ion described in any one of the above (7) to (10) as a part of a precursor structure of ferroelectric ceramics, wherein, in the heteropoly acid ion, the hetero atom includes a group consisting of B, Si, P, S, Ge, As, Mn, Fe and Co, and the poly atom includes a group consisting of Mo, V, W, Ti, Al, Nb and Ta.

(12) The sol-gel solution according to any one of the above (6) to (11), wherein
said sol-gel solution contains a polar solvent.

(13) The sol-gel solution according to the above (12), wherein
said polar solvent is any of methyl ethyl ketone, 1,4-dioxane, 1,2-dimethoxyethane acetamide, N-methyl-2-pyrrolidone, acetonitrile, dichloromethane, nitromethane, trichloromethane, dimethylformamide and monomethylformamide, or a combination of a plurality of these.

(14) The sol-gel solution according to any one of the above (6) to (13), wherein said sol-gel solution contains an unsaturated fatty acid.

(15) The sol-gel solution according to the above (14), wherein said unsaturated fatty acid is any of a monounsaturated fatty acid, a diunsaturated fatty acid, a triunsaturated fatty acid, a tetraunsaturated fatty acid, a pentaunsaturated fatty acid and a hexaunsaturated fatty acid or a combination of a plurality of these;
said monounsaturated fatty acid is any of crotonic acid, myristoleic acid, palmitoleic acid, oleic acid, elaidic acid, vaccenic acid, gadoleic acid, eicosenoic acid, erucic acid and nervonic acid, or a combination of a plurality of these;
said diunsaturated fatty acid is any of linoleic acid, eicosadienoic acid and docosadienoic acid, or a combination of a plurality of these;
said triunsaturated fatty acid is any of linolenic acid, pinolenic acid, eleostearic acid, Mead acid, dihomo-γ-linolenic acid and eicosatrienoic acid, or a combination of a plurality of these;
said tetraunsaturated fatty acid is any of stearidonic acid, arachidonic acid, eicosatetraenoic acid and adrenic acid, or a combination of a plurality of these;
said pentaunsaturated fatty acid is any of bosseopentaenoic acid, eicosapentaenoic acid, osbond acid, clupanodonic acid and tetracosapentaenoic acid, or a combination of a plurality of these; and
said hexaunsaturated fatty acid is either of docosahexaenoic acid or nisinic acid, or a combination of these.

(16) A method for manufacturing a ferroelectric film, including the step of manufacturing the ferroelectric film described in the above (1) to (6) by using any of the sol-gel solutions described in the above (6) to (15).

(17) A film forming method, including the steps of:
coating the sol-gel solution described in any one of the above (6) to (15) on a substrate by a spin coat method, to thereby form a coated film on the substrate;
calcining temporarily the coated film; and
repeating the formation of the coated film and the temporary calcination a plurality of times, to thereby form a ferroelectric material film including a plurality of coated films on the substrate.

(18) The film forming method according to the above (17), wherein:
the thickness of said ferroelectric material film is a thickness more than 300 nm; and
said ferroelectric material film is subjected to a heat treatment, to thereby crystallize collectively said ferroelectric material film.

(19) A method for manufacturing a ferroelectric film, including the steps of :
forming a ferroelectric material film on a substrate by using the film forming method described in the above (17) or (18); and
heat-treating the ferroelectric material film, to thereby form a ferroelectric film composed of a perovskite structure obtained by crystallizing the ferroelectric material film on the substrate,
wherein the ferroelectric film is the ferroelectric film described in the above (1) to (7).

(20) A method for manufacturing a ferroelectric film including the steps of:
preparing a raw material solution containing a heteropoly acid containing Ba, X, Zr, and Ti, and a sol-gel solution containing a polar solvent and an unsaturated fatty acid;
coating said sol-gel solution on a substrate by a spin coat method, to thereby form a coated film on said substrate;
calcining temporarily said coated film at a temperature of 25 to 450° C., to thereby form a ferroelectric material film on said substrate; and
heat-treating said ferroelectric material film at a temperature of 450 to 800° C., to thereby manufacture a ferroelectric film including a perovskite structure obtained by crystallizing said ferroelectric material film.

(21) The method for manufacturing a ferroelectric film according to the above (20), including the step of
repeating the formation of said coated film and said temporary calcination a plurality of times when forming the ferroelectric material film on said substrate, to thereby form a ferroelectric material film including a plurality of coated films.

(22) The method for manufacturing a ferroelectric film according to the above (20) or (21), wherein
said ferroelectric film is the ferroelectric film according to any one of the above (1) to (6).

(23) The method for manufacturing a ferroelectric film according to any one of the above (17) to (22), wherein
the surface of said substrate has a (111)-oriented Pt or Ir film.

(24) The method for manufacturing a ferroelectric film according to any one of the above (17) to (22), wherein
the surface of said substrate has a non-oriented IrOx film, a (111) Pt/IrOx non-oriented electrode, a non-oriented IrOx/Pt (111) electrode, and a (111) Ir electrode.

By pressurizing the coated film in an oxygen atmosphere, the ferroelectric material film can be crystallized even if the surface of the substrate has a non-oriented film.

### Effect of the Invention

According to one embodiment of the present invention, it is possible to produce a ferroelectric film made of a non-lead material.

### BRIEF DESCRIPTION OF THE DRAWINGS

FIG. 1A is a SEM photograph showing surface morphology of (Ba_{0.9}, Ca_{0.1}) (Ti_{0.87}, Zr_{0.13})O₃, and FIG. 1B is a SEM cross-sectional photograph of the ferroelectric film shown in FIG. 1A.

FIG. 2 is a drawing showing a result of performing a hysteresis evaluation of (Ba_{0.9}, Ca_{0.1})(Ti_{0.87}, Zr_{0.13})O₃.

### BEST MODE FOR CARRYING OUT THE INVENTION

Hereinafter, embodiments of the present invention will be described in detail using the drawings. However, it is understood easily by a person skilled in the art that the present invention is not limited to descriptions below, but that the form and detail thereof can be changed variously without departing from the gist and scope thereof. Accordingly, the present invention should not be construed with the limitation to described contents of embodiments shown below.

The ferroelectric film according to the present embodiment is one that is represented by (Baₐα₁₋ₐ) (Ti_{b}β_{1-b})O₃ (α: one or more metal elements among Mg (magnesium), Ca2+ (calcium), Sr (strontium), Li (lithium), Na (sodium), K (potassium), Rb (rubidium), Cs (cesium), Mg (magnesium), Ca2+ (calcium) and Sr (strontium); β: one or more metal elements among Ti (titanium), V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)).

α is preferably an alkali metal element, more preferably Ca.

The above-mentioned (Baₐα₁₋ₐ) (Zr_{b}Ti_{1-b})O₃ is composed of a perovskite structure.

The above-mentioned a and b preferably satisfy following Formulae (1) and (2).
(1) 0.5≦a≦1
(2) 0≦b≦0.5

Next, the method for manufacturing a ferroelectric film according to the present embodiment will be described in detail. The ferroelectric film is composed of a perovskite structure ferroelectric substance represented by (Baₐα₁₋ₐ) (Zr_{b}Ti_{1-b})O₃, where a and b satisfy Formulae (1) and (2) described above.

### (Substrate)

On such a substrate, for example, as a 6-inch silicon wafer, a foundation film oriented in a prescribed crystal face is formed. As the foundation film, for example, a (111)-oriented Pt film or Ir film is used.

A sol-gel solution having a contact angle of not more than 40°, preferably not more than 20° with the substrate is prepared. The sol-gel solution contains a raw material solution including a heteropoly acid including Ba, X, Zr, Ti, a polar solvent and an unsaturated fatty acid.

The sol-gel solution contains a heteropoly acid ion as a part of a precursor structure of ferroelectric ceramics, the heteropoly acid ion being based on a heteropoly acid ion having a Keggin-type structure in which the molecular structure is made non-centrosymmetric to express nonlinearity as a constituent component, wherein at least one poly atom of the heteropoly acid ion is deficient or a part of poly atoms of the heteropoly acid ion is substituted with another atom.

The heteropoly acid ion is one having a Keggin-type structure represented by following Formula: [XM_{y}M′_{12-y}O₄₀]ⁿ⁻ (where, X is a hetero atom, M is a poly atom, M′ is a poly atom different from M, n is a valence number, and y=1 to 11), and the heteropoly acid ion is contained as a part of a precursor structure of ferroelectric ceramics.

Furthermore, the heteropoly acid ion may be one having a Keggin-type structure represented by Formula: [XM₁₁O₃₉]ⁿ⁻ (where, X is a hetero atom, M is a poly atom, and n is a valence number), and the heteropoly acid ion is contained as a part of a precursor structure of ferroelectric ceramics.

Moreover, the heteropoly acid ion is one having a Keggin-type structure represented by following Formula: [XM_{z}M′_{11-z}O₃₉]ⁿ⁻ (where, X is a hetero atom, M is a poly atom, M′ is a poly atom different from M, n is a valence number, and z=1 to 10), and the heteropoly acid ion is contained as apart of a precursor structure of ferroelectric ceramics.

In the heteropoly acid ion, it is also possible that the hetero atom includes a group consisting of B, Si, P, S, Ge, As, Mn, Fe and Co, and that the poly atom includes a group consisting of Mo, V, W, Ti, Al, Nb and Ta, and one including the heteropoly acid ion as a part of a precursor structure of ferroelectric ceramics is also possible.

The polar solvent is any of methyl ethyl ketone, 1,4-dioxane, 1,2-dimethoxyethane acetamide, N-methyl-2-pyrrolidone, acetonitrile, dichloromethane, nitromethane, trichloromethane, dimethylformamide and monomethylformamide, or a combination of a plurality of these.

The unsaturated fatty acid is any of monounsaturated fatty acid, diunsaturated fatty acid, triunsaturated fatty acid, tetraunsaturated fatty acid, pentaunsaturated fatty acid and hexaunsaturated fatty acid, or a combination of a plurality of these.

Examples of the monounsaturated fatty acid include crotonic acid, myristoleic acid, palmitoleic acid, oleic acid, elaidic acid, vaccenic acid, gadoleic acid, eicosenoic acid, erucic acid and nervonic acid, which may be used independently or in combination of a plurality of these.

Examples of the diunsaturated fatty acid include linoleic acid, eicosadienoic acid and docosadienoic acid, which may be used independently or in combination of a plurality of these.

Examples of the triunsaturated fatty acid include linolenic acid, pinolenic acid, eleostearic acid, Mead acid, dihomo-γ-linolenic acid and eicosatrienoic acid, which may be used independently or in combination of a plurality of these.

Examples of the tetraunsaturated fatty acid include stearidonic acid, arachidonic acid, eicosatetraenoic acid and adrenic acid, which may be used independently or in combination of a plurality of these.

Examples of pentaunsaturated fatty acid include bosseopentaenoic acid, eicosapentaenoic acid, osbond acid, clupanodonic acid and tetracosapentaenoic acid, which may be used independently or in combination of a plurality of these.

Examples of the hexaunsaturated fatty acid include docosahexaenoic acid and nisinic acid, which may be used independently or in combination of a plurality of these.

On a substrate of a 6-inch Si wafer having a Pt film (111) oriented formed on the surface thereof, a sol-gel solution was applied, and a contact angle of the sol-gel solution with the substrate measured resulted in not more than 20°. Note that an acceptable contact angle with the substrate has only to have 1 to 40° (preferably 1 to 20°).

By coating the sol-gel solution on the substrate by a spin coat method, a coated film is formed on the substrate, the coated film is temporarily calcined at a temperature of 25 to 450° C. (preferably at 450° C.), and the formation of the coated film and the temporary calcination are repeated a plurality of times to form a ferroelectric material film made of a plurality of coated films on the substrate.

### (Crystallization Method)

By subjecting the ferroelectric material film to a heat treatment at a temperature of 450 to 800° C. (preferably 700° C.), the ferroelectric material film can be crystallized. Conditions of the heat treatment at this time is to perform calcination under a pressurized oxygen atmosphere of 2 to 9.9 atm, and at a temperature increasing rate of 100 to 150° C./sec for 1 to 5 min. Furthermore, the thickness of a ferroelectric material film in crystallizing collectively the ferroelectric material film is preferably not less than 300 nm.

The ferroelectric film thus produced contains almost no air bubbles, even when it is a thick film having a thickness of not less than 500 nm. In other words, by forming a film as described above, a good and thick film can be formed. The reason is that the film has a structure in which organic components disappear almost in the thickness direction and exhibits almost no contraction in the substrate surface, the contraction being at a level that is offset by the expansion due to oxidation. Accordingly, almost no warp is generated in the substrate.

Note that it is also possible, by the repetition of the above-mentioned formation and crystallization of the ferroelectric material film, to form a ferroelectric film having a thickness of not less than 2 μm.

### EXAMPLES

On a 6-inch Si wafer, a Ti film of 10 to 30 nm is formed via a silicon oxide film by a sputtering method. For more information, it was formed by an RF sputtering method. The Ti film functions as an adhesion layer of Pt and silicon oxide. The Ti film was formed under film forming conditions such as an argon gas pressure of 0.2 Pa and a power source output of 0.12 kW for 20 minutes. The film forming was performed at a substrate temperature of 200° C.

Next, by RTA (Rapid Thermal Anneal), the Ti film is subjected to a heat treatment at a temperature of 650° C. for 5 minutes. The heat treatment was performed in an oxygen atmosphere of 9.9 atm and 100 ° C./sec.

Then, on the Ti film, a first Pt film of 100 nm is formed by a sputtering method at a temperature of 550 to 650° C. It was formed under an argon gas pressure of 0.4 Pa, a power source output of DC power 100 W and a film forming time of 25 minutes.

After that, on the first Pt film, a second Pt film is formed by an evaporation method at ordinary temperature. It was formed under 3.3×10⁻³ Torr, a source power of 10 KV and a film forming time of 4 minutes.

Next, the Si wafer is subjected to a heat treatment by RTA at a temperature of 650 to 750 for 1 to 5 minutes. Thus, the 6-inch Si wafer, which has a Pt film (111) oriented formed on the surface, is prepared.

Next, a sol-gel solution having a contact angle of not more than 40°, preferably not more than 20° with the 6-inch Si wafer is prepared. For more information, the sol-gel solution contains a raw material solution including a heteropoly acid including g Ba, Ca, Zr and Ti, a polar solvent and an unsaturated fatty acid.

The raw material solution for forming the ferroelectric film is made by mixing with the heteropoly acid, which is a poly acid of a (X₁MₘOₙ)^{x-} type in which a hetero atom is inserted in a metal oxyacid skeleton. It is the sol-gel solution for forming an oxide film consisting of a poly atom: M=Mo, V, W, Ti, Al, Nb, Ta, and hetero atom means elements other than H and C, preferably M=B, Si, P, S, Ge, As, Fe, Co, Bi.

The polar solvent is any of methyl ethyl ketone, 1,4-dioxane, 1,2-dimethoxyethane acetamide, N-methyl -2 -pyrrolidone acetonitrile, dichloromethane, nitromethane, trichloromethane, dimethylformamide and monomethylformamide, or a combination of a plurality of these.

The unsaturated fatty acid includes, as the monounsaturated fatty acid, crotonic acid, myristoleic acid, palmitoleic acid, oleic acid, elaidic acid, vaccenic acid, gadoleic acid, eicosenoic acid, erucic acid and nervonic acid; as the diunsaturated fatty acid, linoleic acid, eicosadienoic acid and docosadienoic acid; as the triunsaturated fatty acid, linolenic acid, pinolenic acid, eleostearic acid, Mead acid, dihomo-γ-linolenic acid and eicosatrienoic acid; as the tetraunsaturated fatty acid, stearidonic acid, arachidonic acid, eicosatetraenoic acid and adrenic acid; as the pentaunsaturated fatty acid, bosseopentaenoic acid, eicosapentaenoic acid, osbond acid, clupanodonic acid and tetracosapentaenoic acid; and as the hexaunsaturated fatty acid, docosahexaenoic acid and nisinic acid.

Next, on the Si wafer covered with a 6-inch Pt electrode, coating of a sol-gel solution is performed by a spin coat method, to form a first layer coated film on the Si wafer. For more information, 500 μL of the sol-gel solution was applied, the increase from 0 to 500 rpm was performed in 3 seconds, the wafer was held at 500 rpm for 3 seconds, then rotated at 2500 rpm for 60 seconds, and then was stopped.

Then, the first layer coated film is heated at a temperature of 175° C. for 1 minute by a hot plate, and then is temporarily calcined at a temperature of 450° C. for 5 minutes. Consequently, the 100 nm ferroelectric material amorphous film of the first layer is formed on the Si wafer.

Subsequently, in the same manner as for the first layer coated film, a second layer coated film is formed on the first layer ferroelectric material film. After that, in the same manner as for the first layer coated film, the second layer coated film is heated to be temporarily calcined. Consequently, on the first layer ferroelectric material film, the second layer ferroelectric material film having a thickness of 100 nm is formed.

Next, in the same manner as for the second layer coated film, on the second layer ferroelectric material film, a third layer coated film is formed. Subsequently, in the same manner as for the first layer coated film, the third layer coated film is heated to be temporarily calcined. Consequently, on the second layer ferroelectric material film, the third layer ferroelectric material film having a thickness of 100 nm is formed. Thus, a ferroelectric material film having three layers having a thickness of 300 nm can be formed. Note that, in the embodiment, the ferroelectric material film having three layers having a thickness of 300 nm is formed, but, by forming a fourth layer or fifth layer ferroelectric material film, a ferroelectric material film having four layers having a thickness of 400 nm, or having five layers having a thickness of 500 nm may be formed.

Then, by subjecting the ferroelectric material film to a heat treatment by pressurized RTA, crystallization of the ferroelectric material film was performed to form a ferroelectric film. The crystallization was performed by holding the film under heat treatment conditions such as an oxygen atmosphere pressurized to an oxygen partial pressure of 9.9 atm, a temperature increasing rate of 120° C./sec to be raised instantaneously to 700° C., and holding time of 1 minute.

Note that, in the present Example, the ferroelectric film of 300 nm is formed, but it is also possible to form a thicker ferroelectric film.

For more information, after the above-mentioned crystallization, on the ferroelectric material film, the formation of a coated film, heating and temporary calcination are repeated in the same manner as above to form furthermore a ferroelectric material film having three to five layers having a thickness of 300 nm to 500 nm, crystallization of the ferroelectric material film is performed in the same manner as above to form a ferroelectric film, and the formation and the crystallization of the ferroelectric material film are furthermore repeated twice . Consequently, a sample, in which a ferroelectric film consisting of a thick film having a thickness of 1.2 μm to 2 μm is formed on a Si wafer, can be obtained.

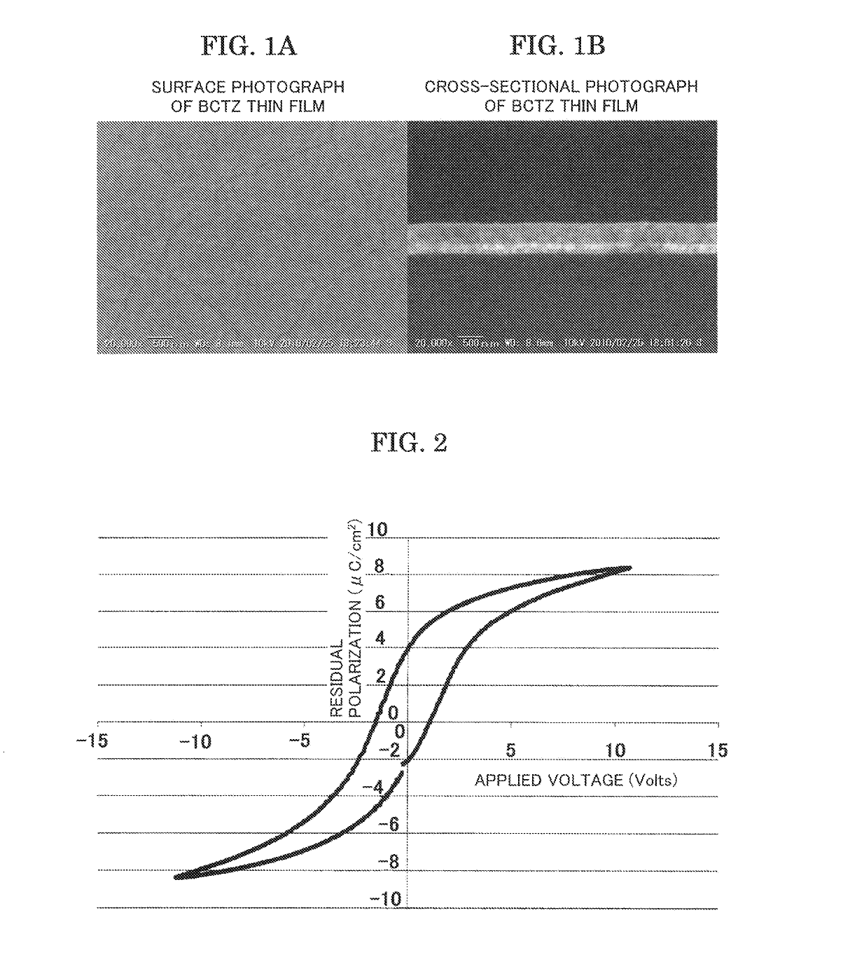

FIG. 1A is a SEM photograph showing surface morphology of (Ba_{0.9},Ca_{0.1}) (Ti_{0.87},Zr_{0.13})O₃, which is a ferroelectric film (thickness 300 nm) of a sample 1, and FIG. 1B is a SEM cross-sectional photograph of the ferroelectric film of the sample 1 shown in FIG. 1A.

FIG. 2 is a drawing of P-E hysteresis characteristics showing a result of implementing the hysteresis evaluation of the ferroelectric film of the sample 1.

As shown in FIG. 2, it was confirmed that the ferroelectric film of the sample 1 has excellent hysteresis characteristics.

1-24. (canceled)

25. A ferroelectric film represented by (Baₐα₁₋ₐ)(Ti_{b}β_{1-b})O₃ (α: one or more metal elements among Mg (magnesium), Sr (strontium), Li (lithium), Na (sodium), K (potassium), Rb (rubidium) and Cs (cesium), β: one or more metal elements among V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)),
wherein a and b satisfy Expressions (1) and (2) below:
(1) 0.5≦a≦1
(2) 0≦b≦0.5.

26. The ferroelectric film according to claim 25, wherein said α is an alkali metal element.

27. The ferroelectric film according to claim 25, wherein said (Baₐα₁₋ₐ)(Ti_{b}Zr_{1-b})O₃ includes a perovskite structure.

28. A sol-gel solution for forming a ferroelectric film on a substrate, comprising a raw material solution mixed with a heteropoly acid including Ba, Zr, and Ti,
wherein the sol-gel solution includes a heteropoly acid ion as a part of a precursor structure of ferroelectric ceramics, the heteropoly acid ion being based on a heteropoly acid ion having a Keggin-type structure in which a molecular structure is made non-centrosymmetric to express nonlinearity as a constituent component, wherein
at least one poly atom of said heteropoly acid ion is deficient or a part of poly atoms of the heteropoly acid ion is substituted with another atom.

29. The sol-gel solution, wherein
said heteropoly acid ion includes the heteropoly acid ion according to claim 28 having a Keggin-type structure represented by a following Formula: [XM_{y}M′_{12-y}O₄₀]ⁿ⁻ (where, X is a hetero atom, M is a poly atom, M′ is a poly atom different from M, n is a valence number, and y=1 to 11), as a part of a precursor structure of ferroelectric ceramics, wherein,
the hetero atom includes a group consisting of B, Si, P, S, Ge, As, Mn, Fe and Co, and the poly atom includes a group consisting of Mo, V, W, Ti, Al, Nb and Ta.

30. The sol-gel solution, wherein
said heteropoly acid ion includes the heteropoly acid ion according to claim 28 having a Keggin-type structure represented by a Formula: [XM₁₁O₃₉]ⁿ⁻ (where, X is a hetero atom, M is a poly atom, and n is a valence number), as a part of a precursor structure of ferroelectric ceramics, wherein,
the hetero atom includes a group consisting of B, Si, P, S, Ge, As, Mn, Fe and Co, and the poly atom includes a group consisting of Mo, V, W, Ti, Al, Nb and Ta.

31. The sol-gel solution, wherein
said heteropoly acid ion includes the heteropoly acid ion according to claim 28 having a Keggin-type structure represented by a following Formula: [XM_{z}M′_{11-z}O₃₉]ⁿ⁻ (where, X is a hetero atom, M is a poly atom, M′ is a poly atom different from M, n is a valence number, and z=1 to 10), as a part of a precursor structure of ferroelectric ceramics, wherein,
the hetero atom includes a group consisting of B, Si, P, S, Ge, As, Mn, Fe and Co, and the poly atom includes a group consisting of Mo, V, W, Ti, Al, Nb and Ta.

32. The sol-gel solution according to claim 28, wherein
said sol-gel solution contains a polar solvent.

33. The sol-gel solution according to claim 32, wherein
said polar solvent is any of methyl ethyl ketone, 1,4-dioxane, 1,2-dimethoxyethane acetamide, N-methyl-2-pyrrolidone, acetonitrile, dichloromethane, nitromethane, trichloromethane, dimethylformamide and monomethylformamide, or a combination of a plurality of these.

34. The sol-gel solution according to claim 28, wherein said sol-gel solution contains an unsaturated fatty acid.

35. The sol-gel solution according to claim 34, wherein said unsaturated fatty acid is any of a monounsaturated fatty acid, a diunsaturated fatty acid, a triunsaturated fatty acid, a tetraunsaturated fatty acid, a pentaunsaturated fatty acid and a hexaunsaturated fatty acid or a combination of a plurality of these;
said monounsaturated fatty acid is any of crotonic acid, myristoleic acid, palmitoleic acid, oleic acid, elaidic acid, vaccenic acid, gadoleic acid, eicosenoic acid, erucic acid and nervonic acid, or a combination of a plurality of these;
said diunsaturated fatty acid is any of linoleic acid, eicosadienoic acid and docosadienoic acid, or a combination of a plurality of these;
said triunsaturated fatty acid is any of linolenic acid, pinolenic acid, eleostearic acid, Mead acid, dihomo-γ-linolenic acid and eicosatrienoic acid, or a combination of a plurality of these;
said tetraunsaturated fatty acid is any of stearidonic acid, arachidonic acid, eicosatetraenoic acid and adrenic acid, or a combination of a plurality of these;
said pentaunsaturated fatty acid is any of bosseopentaenoic acid, eicosapentaenoic acid, osbond acid, clupanodonic acid and tetracosapentaenoic acid, or a combination of a plurality of these; and
said hexaunsaturated fatty acid is either of docosahexaenoic acid or nisinic acid, or a combination of these.

36. A method for manufacturing a ferroelectric film, comprising the step of manufacturing the ferroelectric film according to claim 28 by using a sol-gel solution for forming a ferroelectric film on a substrate, comprising a raw material solution mixed with a heteropoly acid including Ba, Zr, and Ti,
wherein the sol-gel solution includes a heteropoly acid ion as a part of a precursor structure of ferroelectric ceramics, the heteropoly acid ion being based on a heteropoly acid ion having a Keggin-type structure in which a molecular structure is made non-centrosymmetric to express nonlinearity as a constituent component, wherein
at least one poly atom of said heteropoly acid ion is deficient or a part of poly atoms of the heteropoly acid ion is substituted with another atom.

37. A film forming method, comprising the steps of:
coating the sol-gel solution according to claim 28 on a substrate by a spin coat method, to thereby form a coated film on said substrate;
calcining temporarily said coated film; and
repeating said formation of a coated film and said temporary calcination a plurality of times, to thereby form a ferroelectric material film including a plurality of coated films on said substrate.

38. The film forming method according to claim 37, wherein:
the thickness of said ferroelectric material film is a thickness more than 300 nm; and
said ferroelectric material film is subjected to a heat treatment, to thereby crystallize collectively said ferroelectric material film.

39. A method for manufacturing a ferroelectric film, comprising the steps of:
forming a ferroelectric material film on a substrate by using the film forming method according to claim 37; and
heat-treating said ferroelectric material film, to thereby form a ferroelectric film including a perovskite structure obtained by crystallizing said ferroelectric material film on said substrate,
wherein said ferroelectric film is a ferroelectric film represented by (Baₐα₁₋ₐ)(Ti_{b}β_{1-b})O₃ (α: one or more metal elements among Mg (magnesium), Sr (strontium), Li (lithium), Na (sodium), K (potassium), Rb (rubidium) and Cs (cesium), β: one or more metal elements among V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)),
wherein a and b satisfy Expressions (1) and (2) below:
(1) 0.5≦a≦1
(2) 0≦b≦0.5.

40. A method for manufacturing a ferroelectric film comprising the steps of:
preparing a raw material solution containing a heteropoly acid containing Ba, X, Zr, and Ti, and a sol-gel solution containing a polar solvent and an unsaturated fatty acid;
coating said sol-gel solution on a substrate by a spin coat method, to thereby form a coated film on said substrate;
calcining temporarily said coated film at a temperature of 25 to 450° C., to thereby form a ferroelectric material film on said substrate; and
heat-treating said ferroelectric material film at a temperature of 450 to 800° C., to thereby manufacture a ferroelectric film including a perovskite structure obtained by crystallizing said ferroelectric material film,
wherein the sol-gel solution includes a heteropoly acid ion as a part of a precursor structure of ferroelectric ceramics, the heteropoly acid ion being based on a heteropoly acid ion having a Keggin-type structure in which a molecular structure is made non-centrosymmetric to express nonlinearity as a constituent component, wherein
at least one poly atom of said heteropoly acid ion is deficient or a part of poly atoms of the heteropoly acid ion is substituted with another atom.

41. The method for manufacturing a ferroelectric film according to claim 40, comprising the step of
repeating the formation of said coated film and said temporary calcination a plurality of times when forming the ferroelectric material film on said substrate, to thereby form a ferroelectric material film including a plurality of coated films.

42. The method for manufacturing a ferroelectric film according to claim 40, wherein
said ferroelectric film is a ferroelectric film represented by (Baₐα₁₋ₐ)(Ti_{b}β_{1-b})O₃ (α: one or more metal elements among Mg (magnesium), Sr (strontium), Li (lithium), Na (sodium), K (potassium), Rb (rubidium) and Cs (cesium), β: one or more metal elements among V (vanadium), Cr (chromium), Mn (manganese), Fe (iron), Co (cobalt), Ni (nickel), Cu (copper), Zr (zirconium), Nb (niobium), Mo (molybdenum), Ru (ruthenium), Rh (rhodium), Pd (palladium), Ag (silver), Sc (scandium), Y (yttrium), La (lanthanum), Ce (cerium), Pr (praseodymium), Nd (neodymium), Sm (samarium), Eu (europium), Gd (gadolinium), Tb (terbium), Dy (dysprosium), Ho (holmium), Er (erbium), Tm (thulium), Yb (ytterbium), Lu (lutetium), Ha (hafnium) and Ta (tantalum)),
wherein a and b satisfy Expressions (1) and (2) below:
(1) 0.5≦a≦1
(2) 0≦b≦0.5.

43. The method for manufacturing a ferroelectric film according to claim 37, wherein
the surface of said substrate has a (111)-oriented Pt or Ir film.

44. The method for manufacturing a ferroelectric film according to claim 37, wherein
the surface of said substrate has a non-oriented IrOx film, a (111) Pt/IrOx non-oriented electrode, a non-oriented IrOx/Pt (111) electrode, and a (111) Ir electrode.
